(19) United States
(12) Patent Application Publication
(10) Pub. No.: US 2004/0228297 A1
(43) Pub. Date: Nov. 18, 2004

(54) Smart antenna's for cellular modem networks

(76) Inventor: Ihab Elzind, San Jose, CA (US)

Correspondence Address: Derek J. Westberg, Law Offices of Derek J. Westberg, Two North Second Street, Suite 1390, San Jose, CA, 95113, US

(21) Appl. No.: 09/988,116

(22) Filed: Nov. 16, 2001

Related U.S. Application Data
(60) Provisional application No. 60/249,690, filed on Nov. 17, 2000.

(51) Int. Cl. H04Q 7/00

(52) U.S. Cl. 370/328

(57) ABSTRACT

The paper describes the use of smart multibeam antenna or multiple antennas with a smart modem that uses A packet based protocol. Smart antennas are multi narrow beam antennas in one antenna housing as shown in FIG. AM.1 and FIG. AM.2.

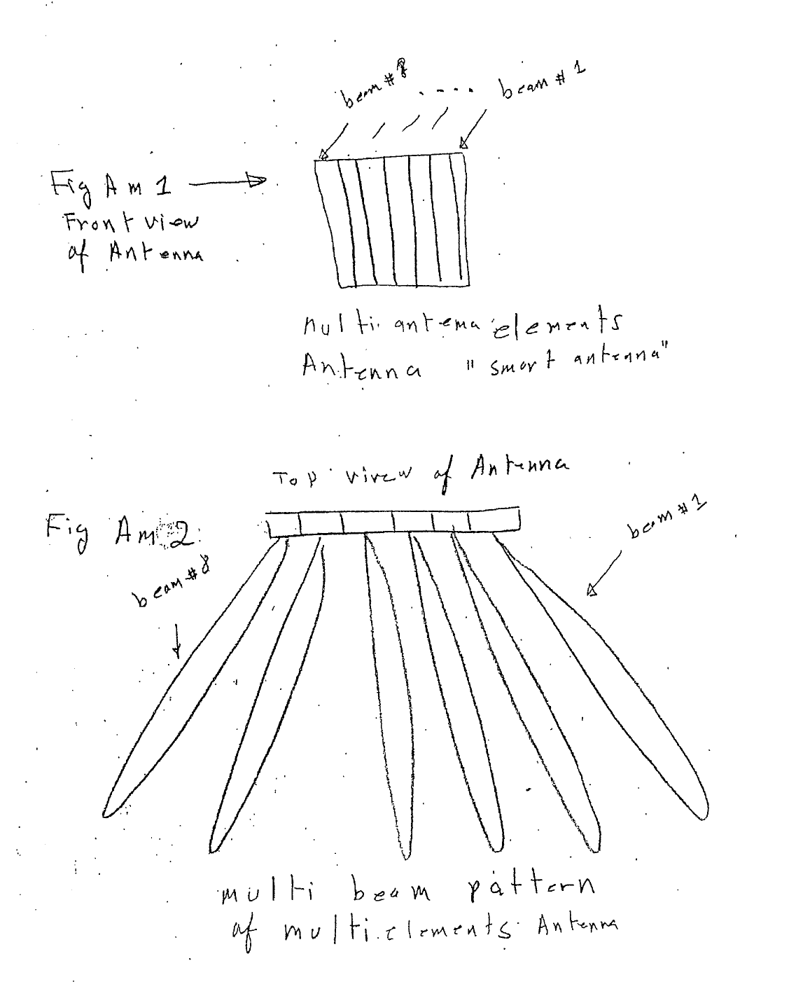

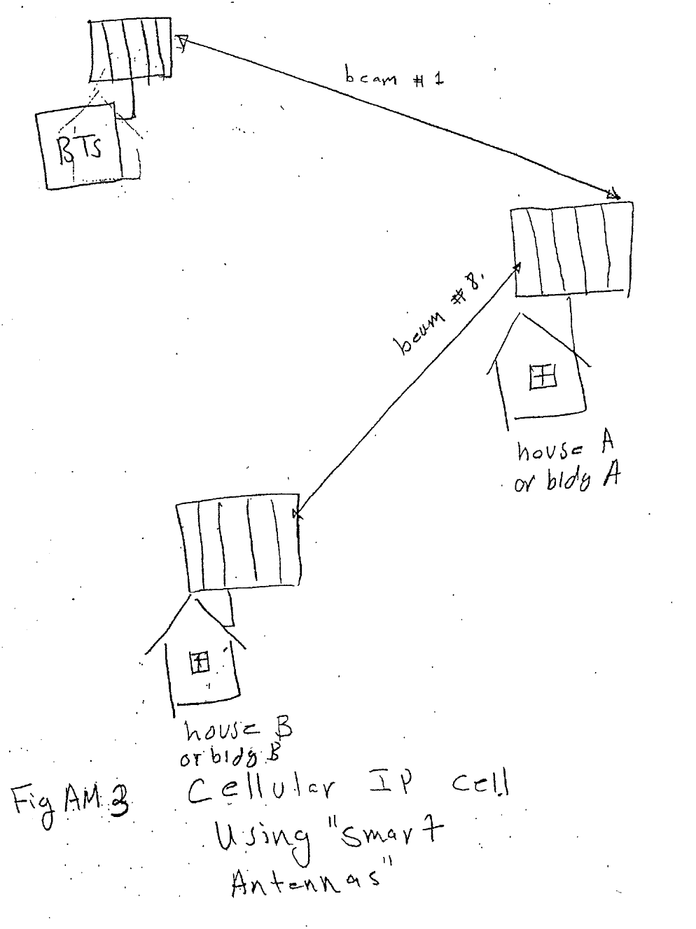

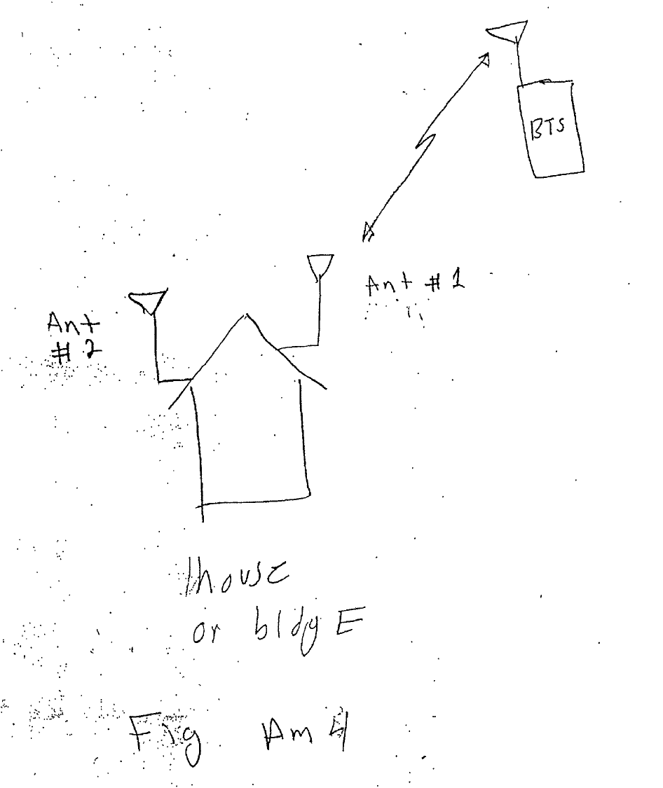

The modem network uses a packet protocol, in which there is a field in the packet that tells the modem which antenna or which antenna beam to use . If the information in such field indicates a routed packet as well as a particular antenna identification number or in modems using smart antennas it will be a beam identification.

FIG. AM.3 shows the BTS communicating over beam #1 to house A or building A and as the modem in house A or building A looks at a field in the packet, it will know t route to house B or building B using beam #8 of the smart antenna. This establishes a routed beam in space versus a beam that covers all directions, making the system more resilient. It will also make the system cause less interference to other systems. FIG. AM.4 shows a house or building E communicating with BTS, and based on a fields in the packet, the modem will determine whether to use antenna #1 or antenna #2 to route the packets. Antenna #1 and antenna #2 could be directional antennas or a combination of directional as well as omnidirectional.

To further define the use of multiple antennas or a multibeam antenna in a modem, Base station network we claim:

1. A packet protocol based wireless network where there is modems and a base station Exchanging packets in a known packet format where there is a field that identifies:
a. An antenna number where the packet is received on and an antenna number Where the packet is retransmitted on at the receiveing modem.
b. In a multibeam antenna a configuration field shall describe the beam number Where the packet is received on and abeam number where the packet is transmitted on.
The beam numbers or the antenna numbers are not necessarley the same, and They can be same if needed:

2. In a configuration where a modem has a multibeam antenna or multiple Antennas, the modem will search for a base station reception by scanning Through the multibeams or the different antennas connect to it until it Finds a base station further eliminating human intervention to adjust the Direction of antennas.
